(19) United States
(12) Patent Application Publication
(10) Pub. No.: US 2008/0150173 A1
(43) Pub. Date: Jun. 26, 2008

(54) Method For Fabricating Luminescent Articles

(76) Inventor: Ivan To, Drayton Valley (CA)

Correspondence Address: DAVIS BUJOLD & Daniels, P.L.L.C., 112 PLEASANT STREET, CONCORD, NH, 03301, US

(21) Appl. No.: 11/814,324

(22) PCT Filed: Jan. 9, 2006
(86) PCT No.: PCT/CA06/00023

§ 371 Date: Jul. 19, 2007

(30) Foreign Application Priority Data
Jan. 19, 2005 (CA) 2,492,994

(51) Int. Cl. B29D 11/00

(52) U.S. Cl. 264/1.1

(57) ABSTRACT

A method for fabricating luminescent articles. A first step involves providing a transparent liquid epoxy having a low viscosity, approximately equivalent to viscosity of water. A second step involves increasing the viscosity of the transparent epoxy by adding powdered luminescent, to arrive at a mixture containing between 40% and 80% luminescent content, as determined by weight. A third step involves pouring the mixture into a mold and allowing the mixture to set to form a luminescent article.

### FIELD OF THE INVENTION

The present invention relates to a method for fabricating luminescent articles and luminescent articles formed in accordance with the teachings of the method.

### BACKGROUND OF THE INVENTION

U.S. Pat. No. 6,207,077 (Bumell-Jones 2001) is an example of a moldable luminescent resin suitable for use in molding luminescent articles. A number of sample formulations are given, each of which contain between 10% and 20% luminescent material, as determined by weight. These percentages are fairly typical within the industry.

### SUMMARY OF THE INVENTION

According to the present invention there is provided a method for fabricating luminescent articles. A first step involves providing a transparent liquid epoxy having a low viscosity, approximately equivalent to viscosity of water. A second step involves increasing the viscosity of the transparent epoxy by adding powdered luminescent, to arrive at a mixture containing between 40% and 80% luminescent content, as determined by weight. A third step involves pouring the mixture into a mould and allowing the mixture to set to form a luminescent article.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a flow diagram containing a sequence of steps for fabricating luminescent articles in accordance with the teachings of the method.

FIG. 2 is a side elevation view, in section, showing the addition of a white reflective backing with clear adhesive after the luminescent article is formed.

FIG. 3 is a side elevation view, in section, illustrating how a white reflective backing may be added as an additional layer of white epoxy during the moulding process.

### DETAILED DESCRIPTION OF THE PREFERRED EMBODIMENT

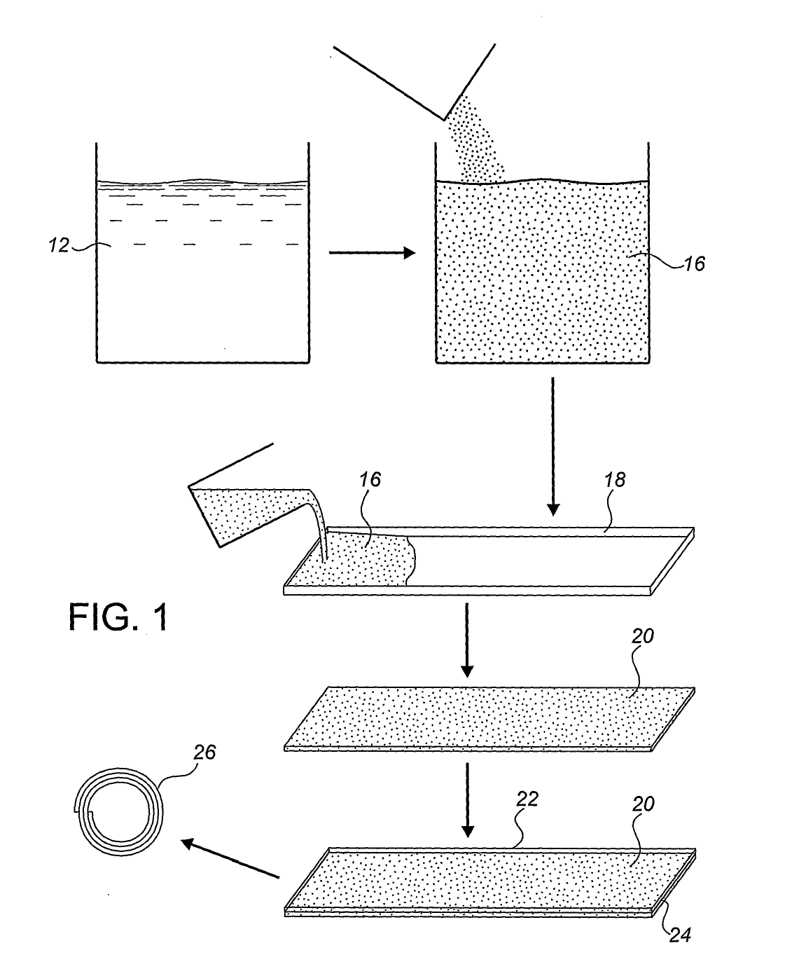

The preferred method for fabricating luminescent articles will now be described with reference to FIG. 1 through FIG. 3.

The objective when developing this method was to reach a higher luminescent content than has previously been considered possible by persons skilled in the art.

Referring to FIG. 1, a first step involves providing a transparent liquid epoxy 12 having a low viscosity, approximately equivalent to viscosity of water. The reason for starting with a low viscosity epoxy is to allow as much luminescent material to be added as possible, without high viscosity affecting the ability to mould the mixture.

A second step involves increasing the viscosity of the transparent epoxy by adding powdered luminescent 14, to arrive at a mixture 16 containing between 40% and 80% luminescent content, as determined by weight. There are various powdered luminescent materials known in the art, so suitable powdered luminescent materials will not be listed. It is has been found that the finer the mesh of the powder used, the greater the quantity of powdered luminescent that can be added.

A third step involves pouring the mixture into a mould 18 and allowing the mixture to set to form a luminescent article 20. The article chosen for illustration are luminescent strips of the kind that are placed on clothing, secured to vehicles, attached to highway markers, mounted in emergency exits of buildings, and for other uses where visibility in the dark is of concern.

As more and more powdered luminescent is added, there is a danger that the luminescent powder will not remain uniform throughout the mixture, but will begin to settle when placed in the mould. It is for that reason that a transparent epoxy is used. When the epoxy is transparent, the uniform distribution of powdered luminescent is no longer of concern. In accordance with the teachings of this method, uneven distribution is an acceptable trade off in order to have a dramatic increase in the percentage luminescent content. The percentage luminescent content has a direct effect upon how bright a luminescent glow is produced and how long the article will remain visible in the dark. Beneficial results have been obtained moulding articles with approximately 60% luminescent content

Another concern expressed in the prior art is that increasing the luminescent content to the thresholds described above will decrease the wear obtained from the resulting luminescent article. Where having a wear surface is a concern, a step is taken of moulding a secondary protective layer 22 of transparent epoxy over one surface 24 of luminescent article 20.

Following the teachings of this method does not affect the ability of one skilled in the art to adjust the properties of the resulting article. The additives can be placed in the epoxy which make the article rigid, or additives can be placed in the epoxy to make the article quite pliable. In tests, luminescent strips were made, which were sufficiently pliable that they could be formed into rolls 26.

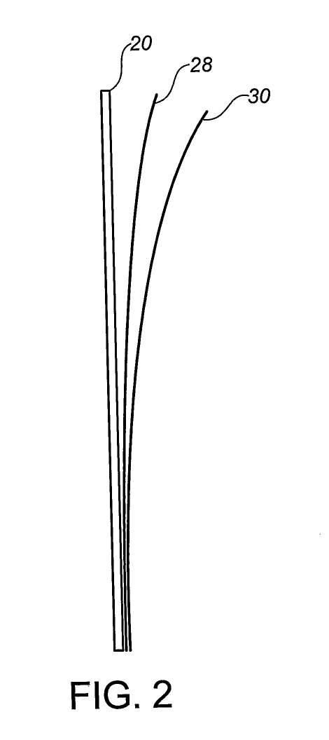

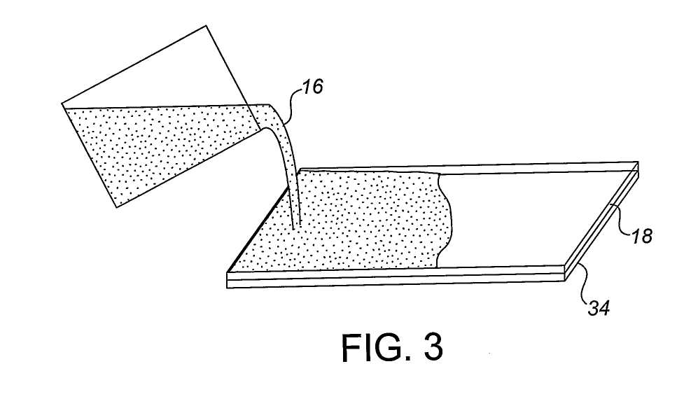

As it known in the art, improved performance of the luminescent material can be obtained by providing a reflective backing. It is preferred that a white reflective backing be used. There are a number of ways in which the white reflective backing may be applied. Referring to FIG. 2, the luminescent article 20 can be formed without the reflective backing. The reflective backing 30 can then be placed on the luminescent article afterwards by suitable means, such as a clear adhesive 28, as illustrated. Referring to FIG. 3, an additional layer of white epoxy 34 can be poured either before or after the transparent luminescent material 16. If the white epoxy layer is poured before, then it will be an underlying layer, as shown in the figure. If the white epoxy layer is poured afterwards, then it must be appreciated that the transparent luminescent material will have to be viewed from the transparent side. Once both epoxies have cured, the resulting product is a single luminescent casting with a white reflective backing.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1-6. (canceled)

7. A method for fabricating luminescent articles, the method comprising the steps of:
providing a transparent liquid epoxy having a low viscosity which is approximately equivalent to viscosity of water;
increasing the viscosity of the transparent epoxy by adding powdered luminescent to arrive at a mixture containing between 40% and 80% luminescent content, as determined by weight;
pouring the mixture into a mold, and
allowing the mixture to set to form a luminescent article with the powdered luminescent being allowed to settle in the mold to create an uneven distribution of powdered luminescent.

8. The method as defined in claim 7, further comprising the step of having the mixture contain approximately 60% luminescent content.

9. The method as defined in claim 7, further comprising the step of molding a secondary protective layer of transparent epoxy over at least one surface of the luminescent article.

10. The method as defined in claim 7, further comprising the step of adding a reflective backing.

11. A product made by a method for fabricating luminescent articles, in which the method comprises the steps of: providing a transparent liquid epoxy having a low viscosity which is approximately equivalent to viscosity of water; increasing the viscosity of the transparent epoxy by adding powdered luminescent to arrive at a mixture containing between 40% and 80% luminescent content, as determined by weight; pouring the mixture into a mold; and allowing the mixture to set to form a luminescent article with the powdered luminescent being allowed to settle in the mold to create an uneven distribution of powdered luminescent.

12. The product as defined in claim 11, wherein the product has a reflective backing.
